(19) United States
(12) Patent Application Publication
(10) Pub. No.: US 2011/0072356 A1
(43) Pub. Date: Mar. 24, 2011

(54) INFORMATION PROCESSING APPARATUS, USER INTERFACE DISPLAY CONTROL METHOD OF THE SAME, AND STORAGE MEDIUM STORING PROGRAM

(75) Inventor: Takeshi Suwabe, Tokyo (JP)

(73) Assignee: CANON KABUSHIKI KAISHA, Tokyo (JP)

(21) Appl. No.: 12/858,989

(22) Filed: Aug. 18, 2010

(30) Foreign Application Priority Data
Sep. 18, 2009 (JP) 2009-218004

(51) Int. Cl. G06F 15/16; G06F 3/048

(52) U.S. Cl. 715/738

(57) ABSTRACT

The device information of an information processing apparatus is acquired. It is determined, based on the acquired device information, whether a function of the information processing apparatus is usable. Upon determining that the function of the information processing apparatus is usable, a file to display the execution instruction window of processing using the function of the information processing apparatus is requested of the server. On the other hand, upon determining that the function of the information processing apparatus is not usable, a file to display a warning window is requested from the server.

### BACKGROUND OF THE INVENTION

1. Field of the Invention

The present invention relates to an information processing apparatus for controlling display of a user interface, a user interface display control method, and a storage medium storing a program.

2. Description of the Related Art

An information processing apparatus such as a PC connected to a Web server on a network is widely known in general to display, on a Web browser, an operation window provided by the Web server. In such a configuration, first, the Web browser of the information processing apparatus requests the operation window of the Web server. Then, in response to the request from the information processing apparatus, a Web application on the Web server sends an HTML file for causing the Web browser to display the operation window to the information processing apparatus. The Web browser of the information processing apparatus analyzes the received HTML file, and displays the operation window based on the description of the HTML file. When the user inputs an instruction in the operation window displayed on the Web browser, the Web browser of the information processing apparatus notifies the Web server of the instruction. Upon receiving the notification, the Web application on the Web server executes processing in accordance with the input instruction.

In recent years, an MFP (Multi Function Peripheral) serving as an information processing apparatus having a scanner and printer also includes a Web browser. The MFP can display the operation window provided by the Web server on the Web browser, and receive various kinds of instructions from the user in accordance with the above-described procedure. The Web server can also express an operation instruction for the MFP or acquire information from it and handle window updating based on a Java®Script incorporated in an HTML file or metadata added to an HTML file.

According to Japanese Patent Laid-Open No. 2007-088665, upon detecting a predetermined event, the notification server notifies the MFP of an address associated with the event on the network, and the MFP acquires window operation from the address. The prior art describes that this allows to provide a variety of window information corresponding to individual events to the MFP.

The operation window of the MFP connected to the Web server is provided by the Web application on the Web server. Hence, the Web server should notify the MFP of an appropriate window.

However, for example, if the user has logged out, and the Web application is not notified of the logout state, window transition on the operation window is performed while keeping the application erroneously recognizing the login state. Alternatively, when an error has occurred in the scanner, and the Web application is not notified of the scanner state, the application can know that a job is unexecutable only when the job is submitted to the MFP after window transition.

Even when the Web application side always monitors and grasps the device information of the MFP to avoid these problems, problems of network traffic and mutual process load arise in order to implement complete real-time processing. In Japanese Patent Laid-Open No. 2007-088665, since a window corresponding to an event is always displayed independently of a change of the MFP state, it is not necessarily possible to display an appropriate window in accordance with a change of the MFP state.

### SUMMARY OF THE INVENTION

An aspect of the present invention is to eliminate the above-mentioned problems with the conventional technology.

The present invention provides an information processing apparatus that acquires device information of its own and requests of a server to send a file to display a window based on the device information, a user interface display control method, and a storage medium storing a program.

The present invention in its first aspect provides, an information processing apparatus which is connected to a server for providing a file to display a user interface, and displays the user interface based on the file, comprising: an acquisition unit configured to acquire device information of the information processing apparatus; a determination unit configured to determine, based on the device information acquired by the acquisition unit, whether a function of the information processing apparatus is usable; a first request unit configured to, upon determining that the function of the information processing apparatus is usable, request, of the server, a file to display an execution instruction window of processing using the function of the information processing apparatus; and a second request unit configured to, upon determining that the function of the information processing apparatus is not usable, request a file to display a warning window of the server.

The present invention in its second aspect provides, a user interface display control method executed in an information processing apparatus which is connected to a server for providing a file to display a user interface, and displays the user interface based on the file, comprising the steps of: acquiring device information of the information processing apparatus; determining, based on the device information acquired in the step of acquiring the device information, whether a function of the information processing apparatus is usable; upon determining that the function of the information processing apparatus is usable, requesting, of the server, a file to display an execution instruction window of processing using the function of the information processing apparatus; and upon determining that the function of the information processing apparatus is not usable, requesting a file to display a warning window of the server.

The present invention in its third aspect provides, a computer-readable storage medium storing a program which is executed in an information processing apparatus which is connected to a server for providing a file to display a user interface, and displays the user interface based on the file, the program causing a computer to function to: acquire device information of the information processing apparatus; determine, based on the acquired device information, whether a function of the information processing apparatus is usable; upon determining that the function of the information processing apparatus is usable, request, of the server, a file to display an execution instruction window of processing using the function of the information processing apparatus; and upon determining that the function of the information processing apparatus is not usable, request a file to display a warning window of the server.

According to the present invention, the information processing apparatus acquires device information of its own, and requests of the server to send a file to display a window based on the device information. It is therefore possible to display an appropriate window based on a change of the state of the information processing apparatus.

Further features of the present invention will become apparent from the following description of exemplary embodiments with reference to the attached drawings.

### BRIEF DESCRIPTION OF THE DRAWINGS

FIG. 1 is a view showing the overall arrangement of a system;

FIG. 2 is a block diagram showing the arrangement of an MFP;

FIG. 3 is a block diagram showing the arrangement of a Web server;

FIG. 4 is a block diagram for explaining the software configuration of the system;

FIG. 5 is a flowchart illustrating the procedure of processing of requesting an operation window;

FIG. 6 shows examples of windows displayed on a Web browser;

FIGS. 7A and 7B are views showing an example of an HTML file representing window information;

FIGS. 8A and 8B are flowcharts illustrating the procedure of processing of requesting window information;

FIG. 9 is a flowchart illustrating the procedure of processing of the Web server;

FIG. 10 is a view showing an example of a maintenance window;

FIG. 11 is a flowchart illustrating the procedure of processing when always monitoring device information; and

FIGS. 12A and 12B are flowcharts illustrating the procedure of another processing of requesting window information.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

Note that the same reference numerals denote the same constituent elements, and a description thereof will be omitted.

### First Embodiment

In the first embodiment, a case will be described in which an MFP 101 as an example of an information processing apparatus acquires device information of its own at a window transition timing, and displays an appropriate window based on the result. Especially, a case will be described in which when a user action has occurred, the MFP 101 acquires device information of its own, and changes the display contents in accordance with the contents of the device information. The user action indicates that, for example, user's pressing a button of a Web browser 440 causes window transition.

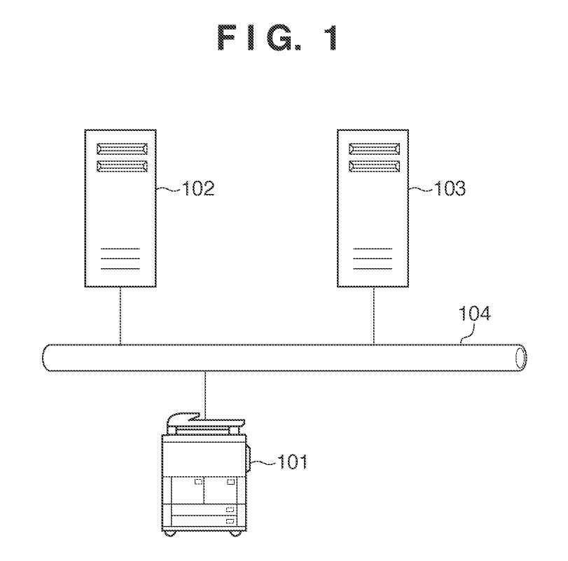

FIG. 1 is a view showing the overall arrangement of a system that performs user interface display control according to this embodiment. The MFP 101 serving as an information processing apparatus, an LDAP (Lightweight Directory Access Protocol) server 102, and a Web server 103 are connected to a LAN 104 so as to be mutually communicable with each other. An FTP (File Transfer Protocol) server (not show n) is also connected to the LAN 104 so that the MFP 101 can send image data to the FTP server by FTP.

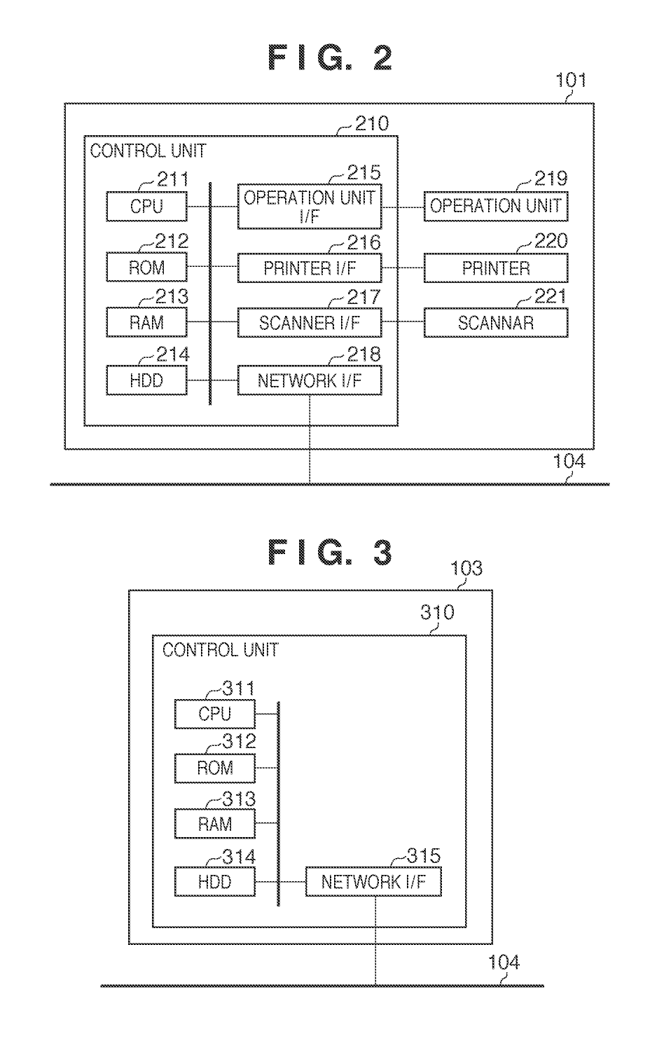

FIG. 2 is a block diagram showing the arrangement of the MFP 101. A control unit 210 including a CPU 211 controls the operation of the entire MFP 101. The CPU 211 reads out control programs stored in a ROM 212, and executes various kinds of control processing such as reading control and sending control. A RAM 213 is used as a temporary storage area such as the main memory or work area of the CPU 211. An HDD 214 stores image data, various kinds of programs, and the like. An operation unit I/F 215 connects an operation unit 219 to the control unit 210. The operation unit 219 includes a liquid crystal display unit having a touch panel function, a keyboard, and the like. The MFP 101 has a Web browser function to be described later. The Web browser of the MFP 101 analyzes an HTML file received from the Web server 103, and displays, on the operation unit 219, an operation window (user interface window) based on the description of the HTML file. A printer I/F 216 connects a printer 220 to the control unit 210. Image data to be printed by the printer 220 is transferred from the control unit 210 to the printer 220 via the printer I/F 216, and printed on a printing medium by the printer 220. A scanner I/F 217 connects a scanner 221 to the control unit 210. The scanner 221 reads an image of a document, generates image data, and inputs it to the control unit 210 via the scanner I/F 217. A network I/F 218 connects the control unit 210 to the LAN 104. The network I/F 218 sends image data or information to another apparatus (for example, the LDAP server 102 or the Web server 103) on the LAN 104, or receives various kinds of information from another apparatus on the LAN 104.

FIG. 3 is a block diagram showing the arrangement of the Web server 103. A control unit 310 including a CPU 311 controls the operation of the entire Web server 103. The CPU 311 reads out control programs stored in a ROM 312, and executes various kinds of control processing. A RAM 313 is used as a temporary storage area such as the main memory or work area of the CPU 311. An HDD 314 stores image data, various kinds of programs, and various kinds of information tables to be described later. A network I/F 315 connects the control unit 310 to the LAN 104. The network I/F 315 sends/receives various kinds of information to/from another external apparatus on the LAN 104.

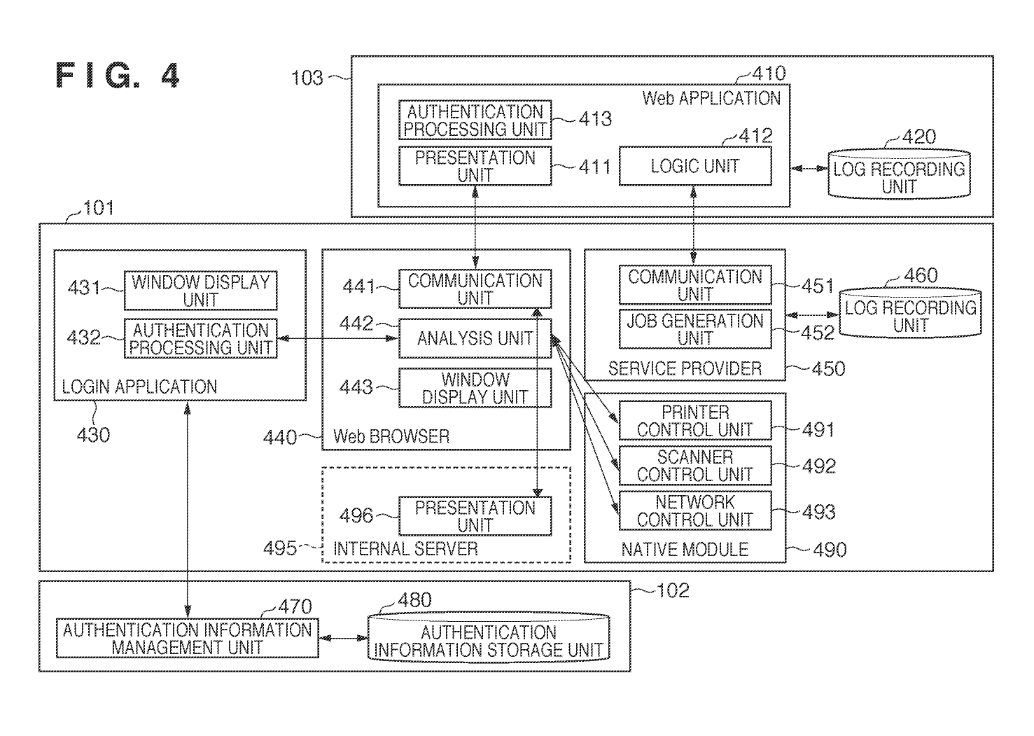

FIG. 4 is a block diagram for explaining the software configuration of the system. The functional units shown in FIG. 4 are implemented by causing the CPUs included in the MFP 101, LDAP server 102, and Web server 103, respectively, to execute control programs.

The MFP 101 includes a login application 430, Web browser 440, service provider 450, log recording unit 460, and native module 490. The login application 430 includes a window display unit 431 and an authentication processing unit 432. The window display unit 431 displays, on the operation unit 219, an authentication window to cause the user to input authentication information necessary for authentication processing to be executed by the authentication processing unit 432. Note that the authentication window is not provided by the Web server 103 but displayed by causing the login application 430 to read out information held in the MFP 101. When the user has input authentication information via the authentication window displayed by the window display unit 431, the authentication processing unit 432 performs user authentication processing using the input authentication information.

The LDAP server 102 includes an authentication information management unit 470 and an authentication information storage unit 480. The authentication information storage unit 480 stores, in advance, authentication information corresponding to users who are permitted to use the MFP 101. The authentication information management unit 470 manages the authentication information stored in the authentication information storage unit 480. When performing authentication processing, the authentication processing unit 432 collates the authentication information input via the authentication window displayed by the window display unit 431 with the authentication information stored in the authentication information storage unit 480. In accordance with the collation result, the user is permitted to use the MFP 101.

The Web browser 440 includes a communication unit 441, analysis unit 442, and window display unit 443. The communication unit 441 communicates with a presentation unit 411 of a Web application 410 in accordance with the HTTP protocol. For example, the communication unit 441 requests the Web application 410 to send an operation window to be displayed on the Web browser 440, or notifies the Web application 410 of a user instruction input via the operation window displayed on the Web browser 440. The analysis unit 442 analyzes an HTML file received from the Web application 410. The HTML file describes the contents of an operation window to be displayed on the Web browser. The analysis unit 442 also analyzes a Java®Script incorporated in an HTML file or metadata (for example, an added XML file) added to an HTML file. The window display unit 443 displays an operation window on the operation unit 219 based on the analysis result of the analysis unit 442.

The native module 490 includes a printer control unit 491, scanner control unit 492, and network control unit 493. The printer control unit 491 acquires the information of the printer 220 via the printer I/F 216. The scanner control unit 492 acquires the information of the scanner 221 via the scanner I/F 217. The network control unit 493 acquires the state of the LAN 104 via the network I/F 218. In accordance with an instruction of the Java®Script incorporated in the HTML file or the added metadata, the analysis unit 442 of the Web browser 440 inquires of the native module 490 about whether the MFP 101 can normally operate. Similarly, the analysis unit 442 inquires of the login application 430 about the user's login/logout state.

The Web server 103 includes the Web application 410 and a log recording unit 420. The Web application 410 includes the presentation unit 411, logic unit 412, and authentication processing unit 413. The presentation unit 411 communicates with the communication unit 441 of the Web browser 440 in the MFP 101, and sends, to the MFP 101, an operation window to be displayed on the Web browser 440 of the MFP 101 in response to a request from it. The presentation unit 411 also receives, from the MFP 101, a user instruction input via the operation window displayed on the Web browser 440 of the MFP 101. Requests from the Web browser 440 of the MFP 101 include user information such as login/logout information.

In accordance with an instruction from the presentation unit 411, the authentication processing unit 413 stores information (for example, login/logout information) equal to the user information received by the presentation unit 411. To request the MFP 101 to execute processing, the logic unit 412 communicates with a communication unit 451 in the service provider 450. For example, the logic unit 412 requests execution of print processing by the printer 220 of the MFP 101, execution of reading processing by the scanner 221, or execution of send processing via the network I/F 218. The logic unit 412 receives the process result. The log recording unit 420 records the result of processing executed by the MFP 101. The process result is written in the log recording unit 420 at a timing it the logic unit 412 has received the process result. Note that the log recording unit 420 also records the progress of updating of the user information (for example, login/logout information) updated in the Web server 103. This information is written in accordance with an instruction from the authentication processing unit 413.

The service provider 450 includes the communication unit 451 and a job generation unit 452. The communication unit 451 receives a process request from the logic unit 412 in the Web application 410. When the Web application 410 has requested execution of processing, the job generation unit 452 generates a job to execute the requested processing, and executes the job. The log recording unit 460 records the job execution result. Note that the log recording unit 460 also records a result of authentication processing executed by the login application 430 and the log of communications with the Web server 103. An internal server 495 indicated by the dotted line in FIG. 4 will be described later in the second embodiment.

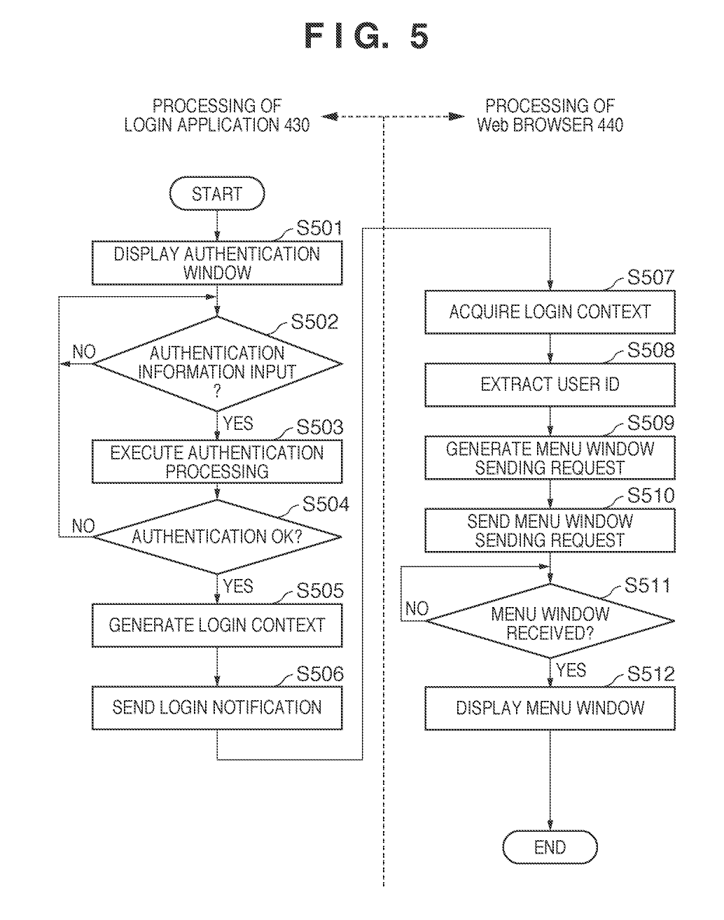

FIG. 5 is a flowchart illustrating the procedure of processing of causing the MFP 101 to perform user authentication processing and send authentication information used for the authentication processing to the Web server 103, thereby requesting an operation window to be displayed on the Web browser of its own. The operations shown in the flowchart of FIG. 5 are implemented by causing the CPU 211 of the MFP 101 to execute control programs. Note that steps S501 to S506 are executed by the login application 430, and steps S507 to S512 are executed by the Web browser 440.

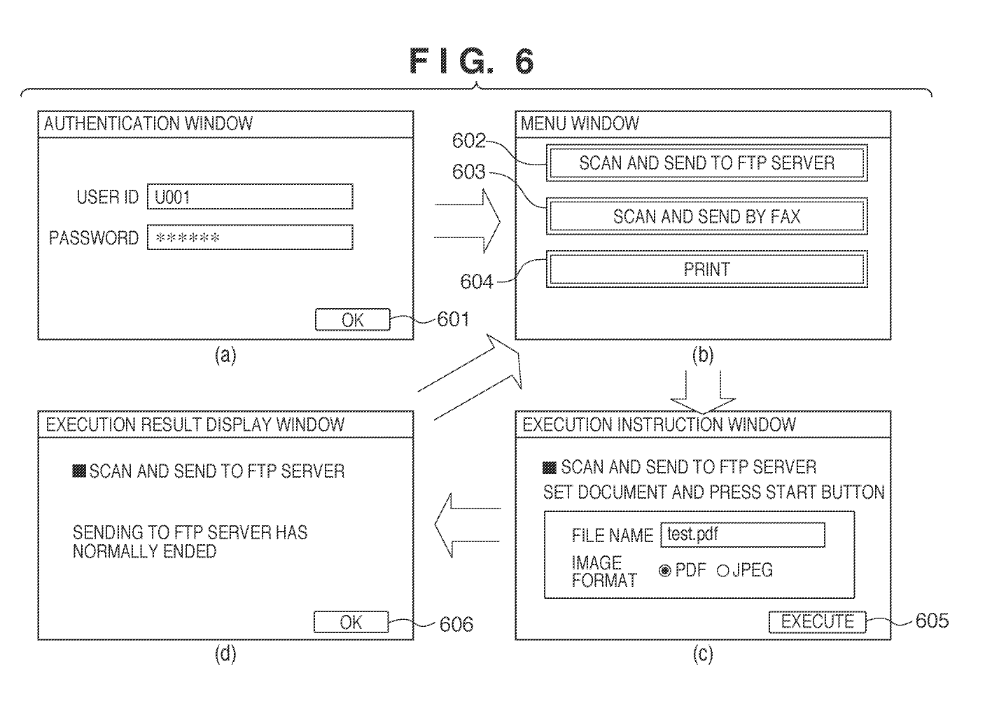

In step S501, the window display unit 431 displays an authentication window on the operation unit 219. In FIG. 6, (a) is a view showing an example of the authentication window displayed in step S501. The windows indicated by (a), (b), (c), and (d) in FIG. 6 are similarly displayed on the operation unit 219. The MFP 101 detects user input of a user ID and password via the authentication window indicated by (a) in FIG. 6.

In step S502, the window display unit 431 determines whether the user has input authentication information. This determination is done based on, for example, whether an OK button 601 of the authentication window indicated by (a) in FIG. 6 has been pressed. Upon determining that the authentication information has been input, the process advances to step S503. The process of step S502 is repeated until it is determined that the authentication information has been input.

In step S503, the authentication processing unit 432 executes authentication processing using the input user ID and password. In step S504, the authentication processing unit 432 communicates with the LDAP server 102, and collates the input user ID and password with information stored in the authentication information storage unit 480 in advance. If the user has normally been authenticated as the result of authentication processing, the process advances to step S505. If the user has not been authenticated, the process returns to step S502 to wait for authentication information input again. In step S505, the authentication processing unit 432 generates a login context corresponding to the authenticated user. The login context is information representing the authenticated user, and includes the user ID input via the authentication window indicated by (a) in FIG. 6. In step S506, the authentication processing unit 432 notifies the Web browser 440 that the user authentication has normally ended, and the user has logged in (login event).

In step S507, the analysis unit 442 of the Web browser 440 acquires the login context generated by the login application 430. In step S508, the analysis unit 442 extracts, from the acquired login context, the user ID input by the user via the authentication window indicated by (a) in FIG. 6. In step S509, the analysis unit 442 generates a menu window sending request to request the Web server 103 to send a menu window that is one of operation windows to be displayed on the Web browser of the MFP 101 and used by the user to instruct execution of processing. The menu window sending request includes the user ID extracted in step S508. In step S510, the communication unit 441 sends the menu window sending request generated by the analysis unit 442 to the Web server 103.

In step S511, the communication unit 441 determines whether the Web server 103 has sent a menu window in response to the menu window sending request sent in step S510. For example, an HTML file is sent from the Web server 103 as window information to display the menu window on the Web browser. Upon determining that the Web server 103 has sent the menu window, the process advances to step S512. Upon determining that the menu window is not received, step S511 is repeated until the menu window is received. In step S512, the window display unit 443 displays a menu window as indicated by (b) in FIG. 6 in accordance with the description of the received HTML file.

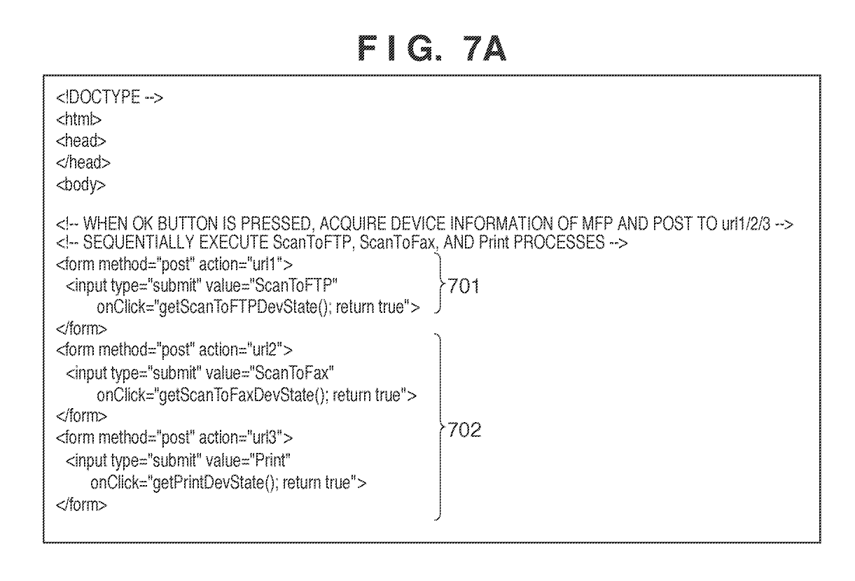

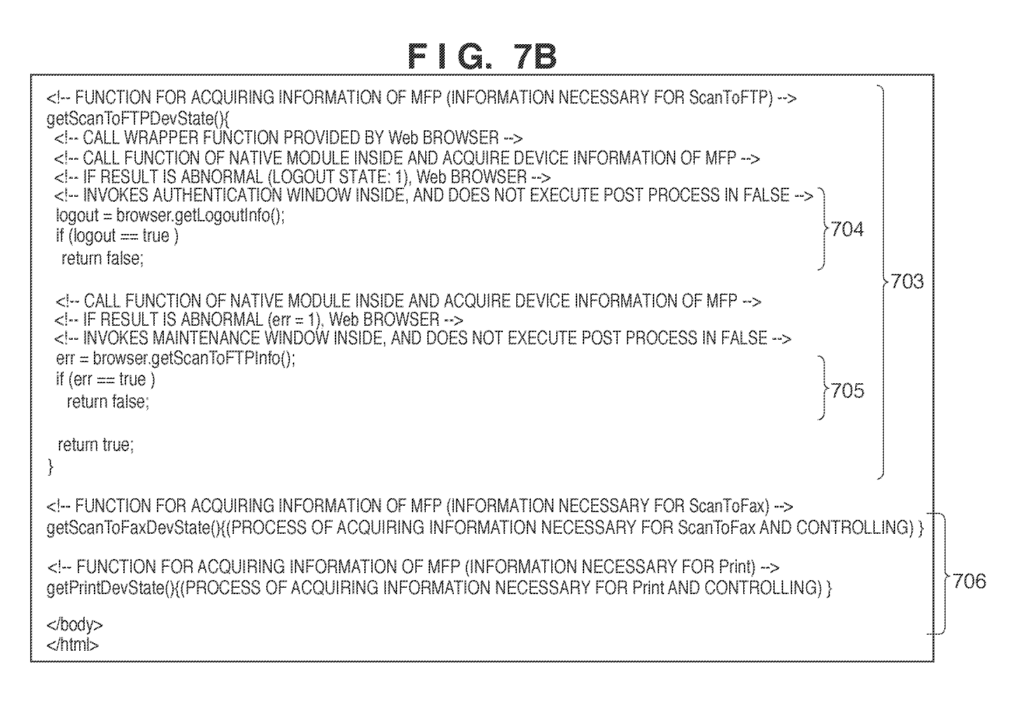

In FIG. 6, (b) is a view showing an example of the menu window displayed in step S512. In FIG. 6, a menu for receiving a designation of the function of the MFP 101 is displayed in (b). For example, in this embodiment, a function button 602 “scan and send to FTP server”, a function button 603 “scan and send by Fax”, and a function button 604 “print” are displayed as selection buttons. When the Web browser 440 detects press of one of the selection buttons, the window transits to an execution instruction window as indicated by (c) in FIG. 6. The window transition is done as in the processes of steps S509 to S512 in (a) of FIG. 6. Processing upon detecting press of the function buttons 602 to 604 will be described with reference to FIGS. 7A and 7B.

In FIG. 6, (c) is a view showing an example of a window to execute a selected function. The window indicated by (c) in FIG. 6 is used to instruct to read an image of a document to generate image data using the scanner 221 of the MFP 101 and send the generated image data to the FTP server on the LAN 104. The window indicated by (c) in FIG. 6 is set to generate image data of PDF format and add a file name “test.pdf”. Upon detecting press of an execute button 605, the processing is actually executed. When the processing is completed, the window transits to an execution result display window as indicated by (d) in FIG. 6. The window transition is done as in the processes of steps S509 to S512 in (a) of FIG. 6.

In FIG. 6, (d) is a view for explaining an example of a window to display the execution result. In (d) of FIG. 6, the execution result is presented to the user. Upon detecting press of an OK button 606, the window returns to that indicated by (b) in FIG. 6. The window transition is done as in the processes of steps S509 to S512 in (a) of FIG. 6.

FIGS. 7A and 7B are views showing part of an example of an HTML file representing the window information of the execution instruction window indicated by (b) in FIG. 6. For convenience, FIGS. 7A and 7B divisionally show an HTML file that is actually one file. The HTML file is sent from the Web server 103, and analyzed by causing the CPU 211 of the MFP 101 to execute a control program. A portion for acquiring the device information of the MFP 101 in accordance with a user action will be described below.

In the expression of Java®Script of the HTML file shown in FIGS. 7A and 7B, a portion 701 indicates process contents when the Web browser 440 in which the button 602 “scan and send to FTP server” is selected has detected press of the button. Upon detecting the press, the Web browser 440 calls a getScanToFTPDevState function 703. The getScanToFTPDevState function 703 acquires login/logout information and the device information of the MFP 101 necessary for executing the function “scan and send to FTP server”.

First, to acquire login/logout information, a getLogoutInfo function is called, as indicated by a portion 704. The getLogoutInfo function is a function provided by the Web browser 440. Upon determining a logout state, the authentication window indicated by (a) in FIG. 6 is invoked inside the Web browser 440. More specifically, the analysis unit 442 of the Web browser 440 invokes the authentication processing unit 432 of the login application 430. The authentication processing unit 432 requests the window display unit 431 to display the authentication window on the operation unit 219, and the window display unit 431 displays the window, as in step S501 of FIG. 5. In this case, the getScanToFTPDevState function 703 ends with “false”, and the POST request to urll is discarded.

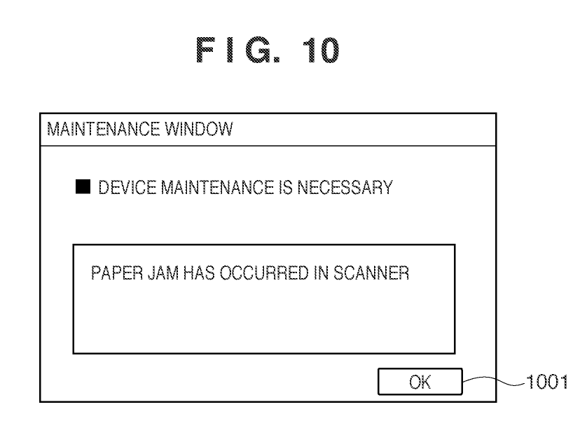

In the logout state, the device information of the MFP 101 needs not be acquired. Hence, the processing (acquisition of the information of the scanner 221 and network (LAN 104)) to be described later is omitted. If the login state (when logout is not true) is set in the processing of the portion 704, the device information of the MFP 101 is acquired. In this case, the information of the scanner 221 and network (LAN 104) which is the device information of the MFP 101 necessary for executing the function “scan and send to FTP server” is acquired. To do this, a getScanToFTPInfo function is called, as indicated by a portion 705. The getScanToFTPInfo function is also a function provided by the Web browser 440. Upon determining that the device information of the MFP 101 is abnormal, a maintenance window shown in FIG. 10 is invoked inside the Web browser 440. More specifically, the analysis unit 442 of the Web browser 440 invokes the Web application 410 of the Web server 103 via the communication unit 441, and acquires and displays the maintenance window information shown in FIG. 10. In this case, the getScanToFTPDevState function 703 ends with “false”, and the POST request to urll is discarded.

A portion 702 indicates process contents when the Web browser 440 has detected press of the button 603 “scan and send by Fax” or the button 604 “Print”. Like the portion 701, when the Web browser 440 detects the press of the button, a getScanToFaxDevState or getPrintDevState function 706 is called. After that, the authentication window indicated by (a) in FIG. 6 or the maintenance window in FIG. 10 is acquired, as in the process of the portion 701.

In this embodiment, implementation by HTML and Java®Script has been exemplified. However, any other implementation form may be adopted. For example, instead of issuing a sending instruction on HTML (submit process), the whole process may be done in the Java®Script (the submit process is described in the Java®Script). A detailed description thereof will be omitted here.

In FIGS. 7A and 7B, the necessary device information of the MFP 101 is acquired even for the function “scan and send to FTP server” and the function “print”. This processing is necessary because the scanner 221, network (LAN 104), and printer 220 need to normally operate for execution of scan (document reading). Conversely, the states of the scanner 221, network (LAN 104), and printer 220 need not be acquired in other windows. Hence, only the window information of the menu window indicated by (b) in FIG. 6 includes the above-described contents. Note that logout information is acquired at all window transition timings after the authentication has been executed.

This is the same as the method of acquiring the device information of the MFP 101 in FIGS. 7A and 7B, and a detailed description thereof will not be repeated.

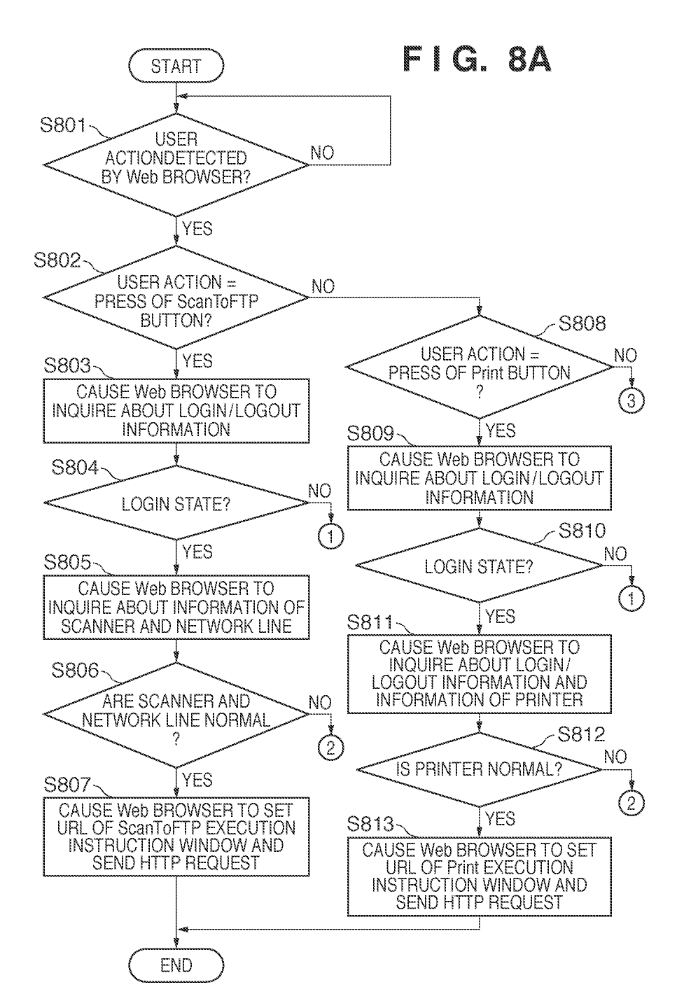

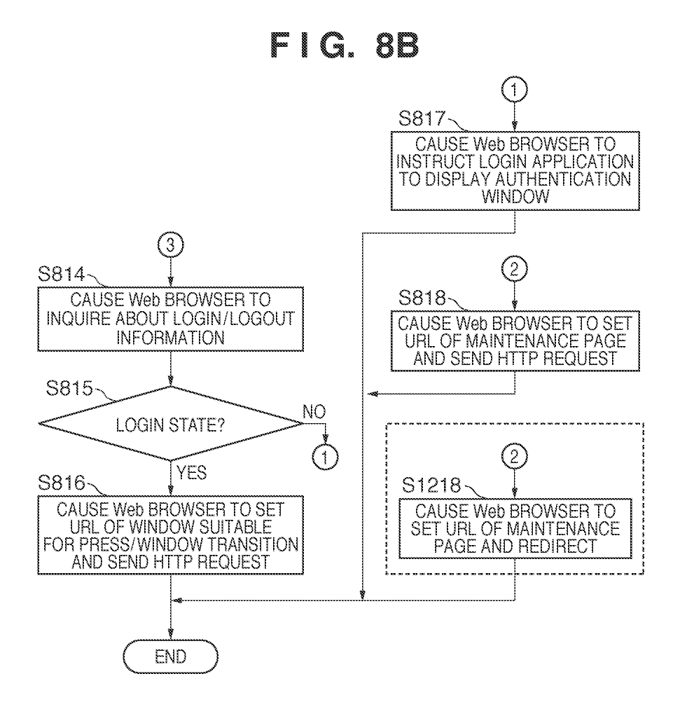

FIGS. 8A and 8B are flowcharts illustrating the procedure of processing when the MFP 101 has detected a user action. The operations shown in the flowchart of FIGS. 8A and 8B are implemented by causing the CPU 211 of the MFP 101 to execute control programs. Step S1218 indicated by the dotted line in FIGS. 8A and 8B will be described later in the second embodiment.

In step S801, the Web browser 440 determines whether a user action has been detected. The Web browser 440 repeats step S801 until a user action is detected. Upon detecting a user action in step S801, the process advances to step S802. In step S802, the Web browser 440 determines whether the user action is press of the button 602 “scan and send to FTP server”. If the user action is press of the button 602 “scan and send to FTP server”, the process advances to step S803. In step S803, the Web browser 440 inquires of the login application 430, and acquires login/logout information in accordance with the Java®Script, as described concerning the portion 704 in FIG. 7B. Then, the process advances to step S804. The Web browser 440 determines whether the login state is set. In the logout state, the process advances to step S817. In the login state, the process advances to step S805.

Step S804 is an example of authentication determination processing.

In step S805, the Web browser 440 inquires of the native module 490, and acquires the information of the scanner 221 and network (LAN 104) in accordance with the Java®Script, as described concerning the portion 705 in FIG. 7B. Then, the process advances to step S806. The Web browser 440 determines whether the information of the scanner 221 and network (LAN 104) is normal. Upon determining that the information is not normal, the process advances to step S818. Upon determining that the information is normal, the process advances to step S807. In step S807, the Web browser 440 sets the URL of the “scan and send to FTP server” window, and sends an HTTP request to the Web server 103. Step S807 is an example of first request processing.

Referring back to step S802, if the Web browser has determined in step S802 that the user action is not press of the button 602 “scan and send to FTP server”, the process advances to step S808. In step S808, the Web browser 440 determines whether the user action is press of the button 604 “print”. Upon determining that the user action is press of the button 604 “print”, the process advances to step S809. In step S809, the Web browser 440 inquires of the login application 430, and acquires login/logout information. Then, the process advances to step S810. The Web browser 440 determines whether the login state is set. In the logout state, the process advances to step S817. In the login state, the process advances to step S811.

In step S811, the Web browser 440 inquires of the native module 490, and acquires the information of the printer 220. Then, the process advances to step S812. The Web browser 440 determines whether the information of the printer 220 is normal. Upon determining that the information is not normal, the process advances to step S818. Upon determining that the information is normal, the process advances to step S813. In step S813, the Web browser 440 sets the URL of the “print” window, and sends an HTTP request to the Web server 103.

Note that when the Web browser 440 has detected press of the button 603 “scan and send by Fax”, the same processing as in steps S802 to S807 or S808 to S813 is performed, although not illustrated in this flowchart.

Referring back to step S808, if the Web browser has determined in step S808 that the user action is not press of the button 604 “print”, the process advances to step S814. In step S814, the Web browser 440 inquires of the login application 430, and acquires login/logout information. The window in which the processing is performed corresponds to a window for which the Web browser 440 has detected a transition request after authentication. The window for which a transition request is detected indicates, for example, the execution result display window indicated by (d) in FIG. 6. However, the menu window indicated by (b) in FIG. 6 branches in step S802 or S808 where the device information of the MFP 101 is acquired, and is therefore not included in the window for which a transition request is detected. Then, the process advances to step S815. The Web browser 440 determines whether the login state is set. Upon determining that the logout state is set, the process advances to step S817. Upon determining that the login state is set, the process advances to step S816. In step S816, the Web browser 440 sets the URL of the window where the transition is detected, and sends an HTTP request to the Web server 103.

The process of step S817 is performed when the Web browser 440 has determined in step S804, S810, or S815 that the logout state is set. In step S817, the Web browser 440 invokes the login application 430, and the login application 430 displays the authentication window indicated by (a) in FIG. 6. This means that regardless of the transition request to the execution instruction window for “scan and send to FTP server” indicated by (c) in FIG. 6, the window transits not to that window but to the authentication window indicated by (a) in FIG. 6. That is, at this point of time, displaying the authentication window indicated by (a) in FIG. 6 is more appropriate than displaying the execution instruction window indicated by (c) in FIG. 6. Step S817 is an example of third request processing.

The process of step S818 is performed when the Web browser 440 has determined in step S806 or S812 that the device information of the MFP 101 is abnormal. In step S818, the Web browser 440 displays a window received by setting the URL of the maintenance window (warning window) in FIG. 10 (to be described later) and sending an HTTP request to the Web server 103. This means that regardless of the transition request to, for example, the execution instruction window for “scan and send to FTP server” indicated by (c) in FIG. 6, the window transits not to that window but to the maintenance window in FIG. 10. That is, at this point of time, displaying the maintenance window in FIG. 10 is more appropriate than displaying the execution instruction window indicated by (c) in FIG. 6 because the MFP 101 is abnormal. Step S818 is an example of second request processing.

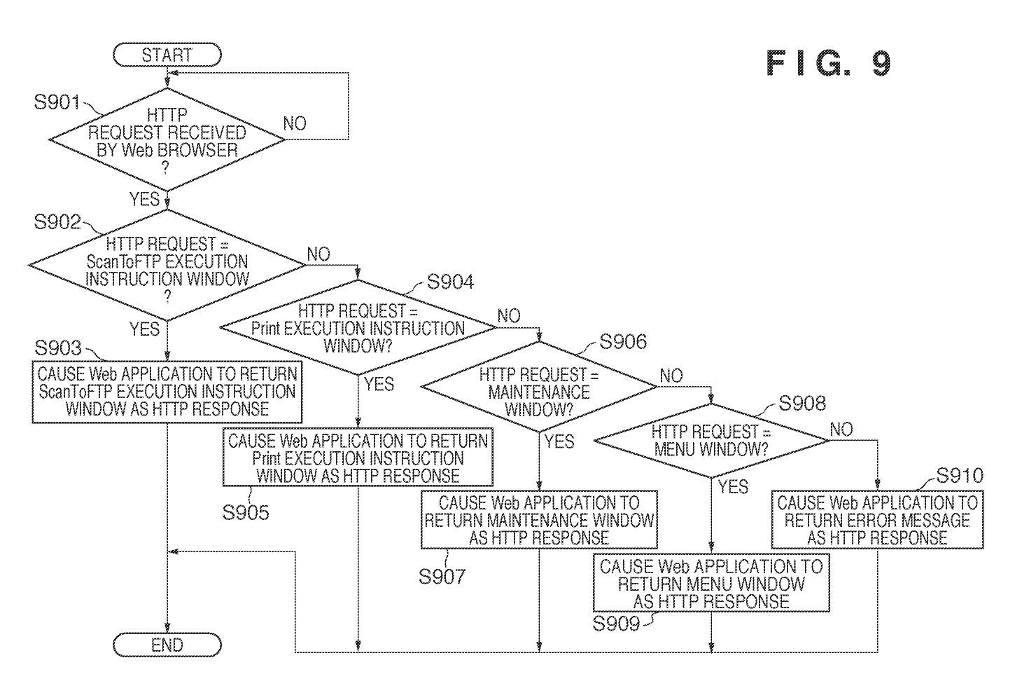

FIG. 9 is a flowchart for explaining the operation of the Web server 103 upon receiving an HTTP request from the MFP 101. The operations shown in the flowchart of FIG. 9 are implemented by causing the CPU 311 of the Web server 103 to execute control programs.

In step S901, the Web application 410 of the Web server 103 determines whether an HTTP request has been received from the MFP 101. Step S901 is repeated until a request is received. Upon receiving a request, the process advances to step S902. In step S902, the Web application 410 determines whether the request contents indicate the execution instruction window indicated by (c) in FIG. 6 for the function “scan and send to FTP server”.

Upon determining that the request contents indicate the execution instruction window for the function “scan and send to FTP server”, the process advances to step S903. The Web application 410 sends the window to the MFP 101 as a response. On the other hand, upon determining that the request contents do not indicate the execution instruction window, the process advances to step S904. In step S904, the Web application 410 determines whether the request contents indicate the execution instruction window for the function “print”. Upon determining that the request contents indicate the execution instruction window for the function “print”, the process advances to step S905. The Web application 410 sends the execution instruction window to the MFP 101 as a response. On the other hand, upon determining that the request contents do not indicate the execution instruction window, the process advances to step S906. The Web application 410 determines whether the request contents indicate the maintenance window. Upon determining that the request contents indicate the maintenance window, the process advances to step S907. The Web application 410 sends the maintenance window to the MFP 101 as a response. On the other hand, upon determining that the request contents do not indicate the maintenance window, the process advances to step S908.

In step S908, the Web application 410 determines whether the request contents indicate the menu window. Upon determining that the request contents indicate the menu window, the process advances to step S909. The Web application 410 sends the menu window to the MFP 101 as a response. On the other hand, upon determining that the request contents do not indicate the menu window, the process advances to step S910. The Web application 410 sends an error message to the MFP 101 as an HTTP response.

FIG. 10 is a view showing an example of the maintenance window which is displayed when the Web browser 440 acquires the device information of the MFP 101, and determines that the execution instruction window indicated by (c) in FIG. 6 should not be displayed in FIGS. 8A and 8B. The window shown in FIG. 10 represents that paper jam has occurred in the scanner. Upon detecting press of an OK button 1001, the Web browser 440 sends a request to the Web server 103 to return to the menu window indicated by (b) in FIG. 6.

According to this embodiment, the MFP 101 acquires the device information of its own at a window transition timing in the MFP 101, and determines whether the window is appropriate at that point of time. It is determined based on the result whether to directly display the window or change to a window acquisition request for appropriate window information. This enables appropriate window display. That is, since the MFP 101 requests a window based on the result of acquisition of the device information of its own, any wasteful device information sending to the Web application 410 of the Web server 103 can be omitted. This consequently contributes to reduction of process loads on both sides, and allows to prevent an increase in network traffic. In addition, since the contents of information acquisition change for each user action, wasteful processing and window display can be omitted.

### Second Embodiment

In the second embodiment, a case in which an internal server 495 of an MFP 101 generates the maintenance window shown in FIG. 10 will be described in addition to the arrangements described in the first embodiment. Only differences from the first embodiment will be explained below.

The arrangement of this embodiment is the same as that shown in FIG. 4, including the portion indicated by the dotted line. In this embodiment, the MFP 101 incorporates the internal server 495. The internal server 495 includes a presentation unit 496. The presentation unit 496 communicates with a communication unit 441 of a Web browser 440, and sends, to the MFP 101, an operation window to be displayed on the Web browser 440 in response to a request from the Web browser 440. The presentation unit 496 also receives, from the MFP 101, a user instruction input via the operation window displayed on the Web browser 440.

In this embodiment, the presentation unit 496 handles only the maintenance window shown in FIG. 10 of the first embodiment. However, the presentation unit 496 is not restricted to handling only the maintenance window in FIG. 10.

In this embodiment, the process of step S1218 of FIGS. 8A and 8B is performed when the Web browser 440 has determined in step S806 or S812 that the device information of the MFP 101 is abnormal. In step S1218, the Web browser 440 displays a window received by setting the URL of the maintenance window in FIG. 10 and sending an HTTP request to the internal server 495. In this embodiment, the internal server 495 handles the URL of the window shown in FIG. 10 in this embodiment. More specifically, the communication unit 441 of the Web browser 440 performs redirect processing so as to send the HTTP request to the presentation unit 496 of the internal server 495. The URL held by the internal server 495 as the redirect destination is predetermined. The communication unit 441 of the Web browser 440 knows the URL in advance, and executes redirect processing using the URL.

As in the first embodiment, upon receiving a transition request to, for example, the execution instruction window for “scan and send to FTP server” indicated by (c) in FIG. 6, the window transits not to that window but to the maintenance window in FIG. 10. That is, at this point of time, displaying the maintenance window in FIG. 10 is more appropriate than displaying the execution instruction window indicated by (c) in FIG. 6.

In this embodiment, the number of window requests to a Web server 103 can further be decreased. This contributes to further reduction of process load of the Web server 103, and allows to prevent an increase in network traffic.

### Third Embodiment

In the third embodiment, a case will be described in which a Web browser 440 always monitors login/logout information and the device information of an MFP 101.

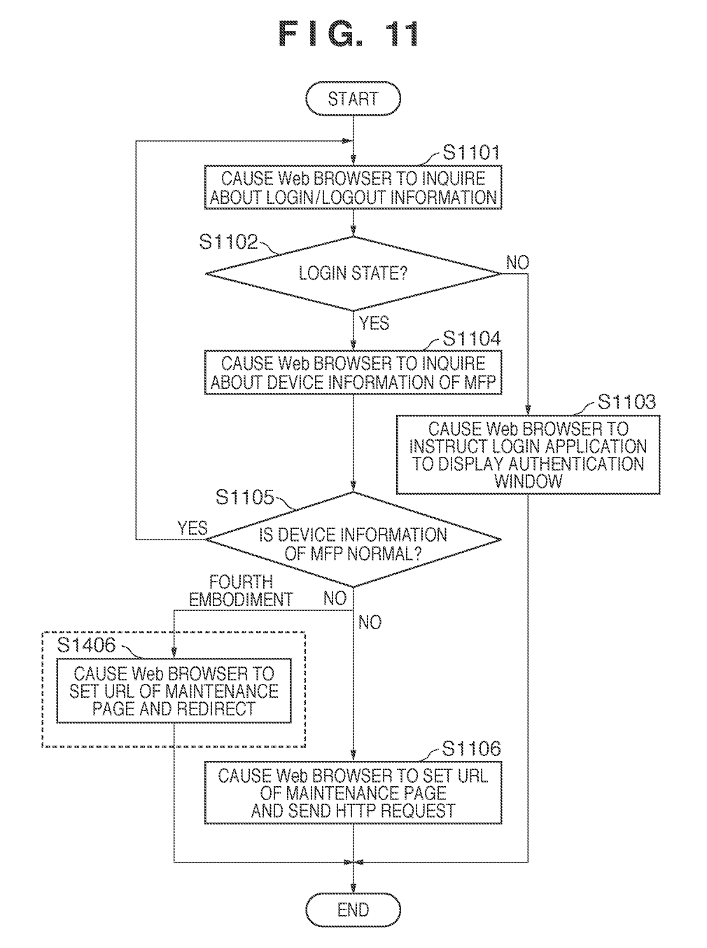

FIG. 11 is a flowchart illustrating the procedure of processing when the Web browser 440 of the MFP 101 always monitors login/logout information and the device information of the MFP 101. The Web browser 440 monitors login/logout information and the device information of the MFP 101 by repeating steps S1101 to S1105 to be described below. The operations shown in the flowchart of FIG. 11 are implemented by causing a CPU 211 of the MFP 101 to execute control programs. The dotted line portion (S1406) in FIG. 11 will be described later in the fourth embodiment.

In step S1101, the Web browser 440 inquires of a login application 430, and acquires login/logout information. Then, the process advances to step S1102, and the Web browser 440 determines whether the login state is set. Upon determining that the logout state is set, the process advances to step S1103. In step S1103, the Web browser 440 invokes the login application 430, and the login application 430 displays the authentication window indicated by (a) in FIG. 6. On the other hand, upon determining in step S1102 that the login state is set, the process advances to step S1104. In step S1104, the Web browser 440 inquires of a native module 490, and acquires the device information of the MFP 101 including a scanner 221, network (LAN 104), and printer 220. Then, the process advances to step S1105. The Web browser 440 determines whether the information of the scanner 221, network (LAN 104), printer 220, and the like is normal.

Upon determining that the information is not normal, the process advances to step S1106. The Web browser 440 sets the URL of the maintenance window in FIG. 10, and sends an HTTP request to the Web server 103. Upon determining that the information is normal, the process returns to step S1101 to monitor the login/logout information and the device information of the MFP 101 again.

According to this embodiment, the MFP 101 always monitors the device information of its own, and determines whether the window is appropriate at the timing of acquisition. Based on the result, an appropriate window acquisition request is sent to change the window display. This enables appropriate window display. In this embodiment, upon determining in step S1105 that the device information is normal, an instruction of processing using that function may be received, and an HTTP request may be sent to the Web server.

### Fourth Embodiment

In the fourth embodiment, a case will be described in which a Web browser 440 always monitors login/logout information and the device information of an MFP 101, and an internal server 495 of the MFP 101 generates the maintenance window shown in FIG. 10. Only differences from the third embodiment will be explained below.

In this embodiment, in step S1406 of FIG. 11, the Web browser 440 sets the URL of the maintenance window in FIG. 10, and sends an HTTP request to the internal server 495. This allows to display the maintenance window in FIG. 10 without inquiring of a Web server 103.

According to this embodiment, the number of window requests to the Web server 103 can further be decreased. This allows to further reduce process load of the Web server 103 and prevent an increase in network traffic.

### Fifth Embodiment

In the fifth embodiment, a case will be described in which a Web browser 440 acquires logout information or the device information of an MFP 101 upon receiving window information.

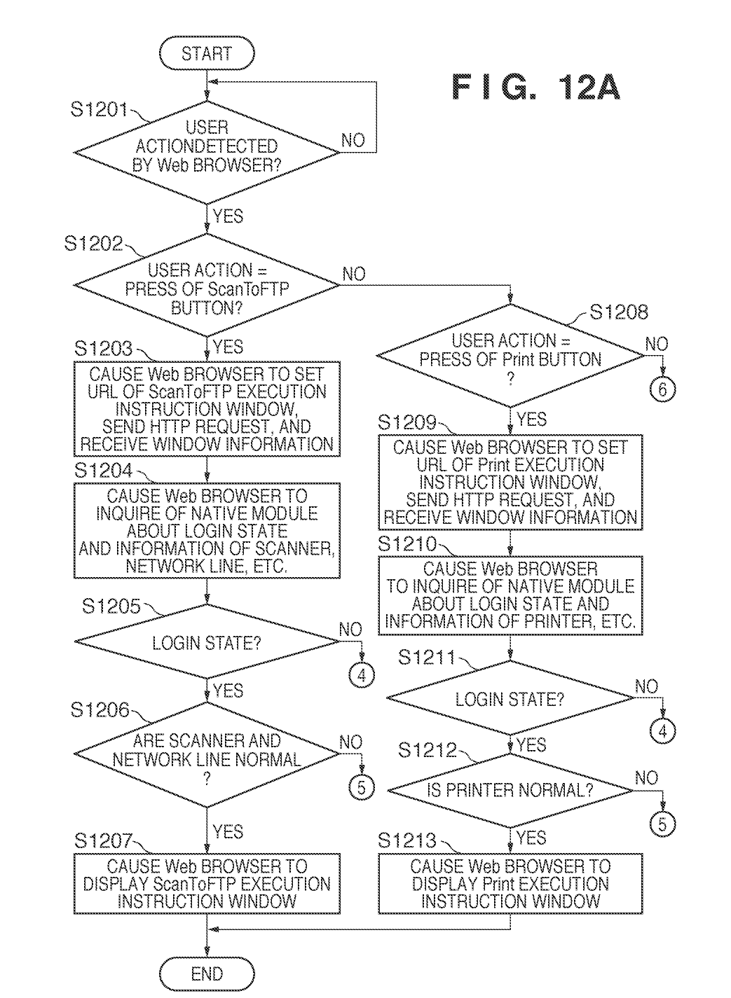

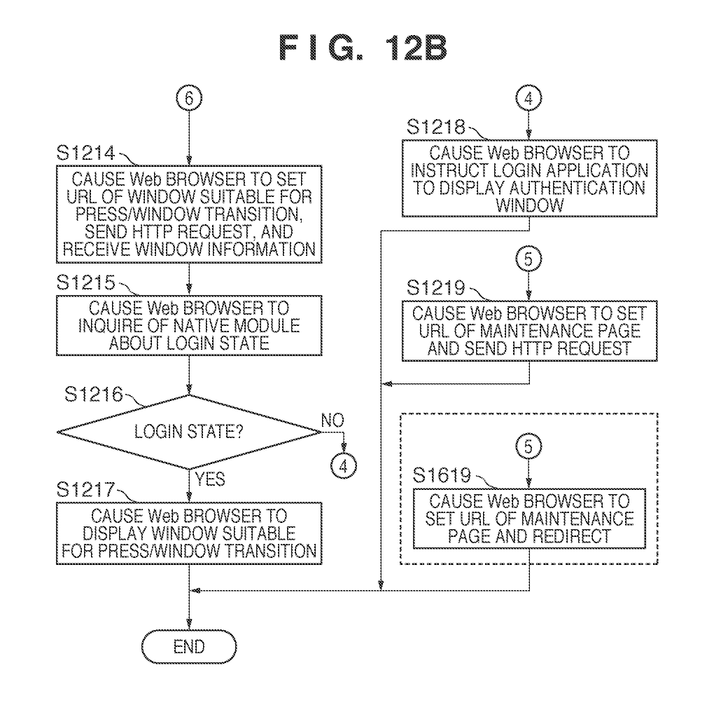

FIGS. 12A and 12B are flowcharts illustrating the procedure of processing performed when the MFP 101 detects a user action and then acquires logout information or the device information of the MFP 101 upon receiving window information. The operations shown in the flowchart of FIGS. 12A and 12B are implemented by causing a CPU 211 of the MFP 101 to execute control programs. The dotted line portion (S1619) in FIGS. 12A and 12B will be described later in the sixth embodiment.

In step S1201, the Web browser 440 determines whether a user action has been detected. The Web browser 440 repeats the process of step S1201 until a user action is detected. When the Web browser 440 detects a user action in step S1201, the process advances to step S1202. In step S1202, it is determined whether the user action is press of a button 602 “scan and send to FTP server”. If the user action is determined to be press of the button 602 “scan and send to FTP server”, the process advances to step S1203.

In step S1203, the Web browser 440 sends an acquisition request of execution instruction window information for “scan and send to FTP server” indicated by (c) in FIG. 6 to a Web server 103, and then receives the window information. In step S1204, the Web browser 440 inquires of a native module 490 about login/logout information and the device information of the MFP 101 in accordance with the window information received in step S1203. In step S1205, the Web browser 440 determines whether the login state is set. Upon determining that the logout state is set, the process advances to step S1218. Upon determining that the login state is set, the process advances to step S1206. In step S1206, the Web browser 440 determines whether the information of a scanner 221 and network (LAN 104) is normal. Upon determining that the information is not normal, the process advances to step S1219. Upon determining that the information is normal, the process advances to step S1207. The Web browser 440 displays the execution instruction window for “scan and send to FTP server indicated by (c) in FIG. 6.

Referring back to step S1202, if the Web browser has determined in step S1202 that the user action is not press of the button 602 “scan and send to FTP server”, the process advances to step S1208 to determine whether the user action is press of a button 604 “print”. Upon determining that the user action is press of the button 604 “print”, the process advances to step S1209. In step S1209, the Web browser 440 sends an acquisition request of execution instruction window information for “print” (not shown) to the Web server 103, and then receives the window information. In step S1210, the Web browser 440 inquires of the native module 490 about login/logout information and the device information of the MFP 101 in accordance with the window information received in step S1210.

In step S1211, the Web browser 440 determines whether the login state is set. Upon determining that the logout state is set, the process advances to step S1218. Upon determining that the login state is set, the process advances to step S1212. In step S1212, the Web browser 440 inquires of the native module 490, acquires the information of a printer 220, and determines whether the information of the printer 220 is normal. Upon determining that the information is not normal, the process advances to step S1219. Upon determining that the information is normal, the process advances to step S1213. The Web browser 440 displays the execution instruction window for “print”.

Note that when the Web browser 440 has detected press of a function button 603 “scan and send by Fax”, the same processing as in steps S1202 to S1207 or S1208 to S1213 is performed, although not illustrated in this flowchart.

Referring back to step S1208, if the Web browser has determined in step S1208 that the user action is not press of the button 604 “print”, the process advances to step S1214. The Web browser 440 sets the URL of the window for which a transition request is detected, and acquires window information. In step S1215, the Web browser 440 inquires of a login application 430, and acquires login/logout information. In step S1216, the Web browser 440 determines whether the login state is set. Upon determining that the logout state is set, the process advances to step S1218. Upon determining that the login state is set, the process advances to step S1217. The Web browser 440 displays the window for which the transition request is detected. The window for which a transition request is detected indicates, for example, the execution result display window indicated by (d) in FIG. 6.

The process of step S1218 is performed when the Web browser 440 has determined in step S1205, S1211, or S1216 that the logout state is set. In step S1218, the Web browser 440 invokes the login application 430, and the login application 430 displays the authentication window indicated by (a) in FIG. 6. This means that regardless of the transition request to the execution instruction window for “scan and send to FTP server” indicated by (c) in FIG. 6, the window transits not to that window but to the authentication window indicated by (a) in FIG. 6. That is, at this point of time, displaying the authentication window indicated by (a) in FIG. 6 is more appropriate than displaying the execution instruction window indicated by (c) in FIG. 6.

The process of step S1219 is performed when the Web browser 440 has determined in step S1206 or S1212 that the device information of the MFP 101 is abnormal. In step S1219, the Web browser 440 sets the URL of the maintenance window in FIG. 10, and sends an HTTP request to the Web server 103. This means that regardless of the transition request to, for example, the execution instruction window for “scan and send to FTP server” indicated by (c) in FIG. 6, the window transits not to that window but to the maintenance window in FIG. 10. That is, at this point of time, displaying the maintenance window in FIG. 10 is more appropriate than displaying the execution instruction window indicated by (c) in FIG. 6.

According to this embodiment, based on received window information, the MFP 101 acquires the device information of its own immediately before displaying the window, and determines whether the window is appropriate at that point of time. Based on the result, an acquisition request for appropriate window information is sent, and window display is changed. This enables appropriate window display.

### Sixth Embodiment

In the sixth embodiment, a case will be described in which a Web browser 440 acquires logout information or the device information of an MFP 101 upon receiving window information, and an internal server 495 of the MFP 101 generates the maintenance window shown in FIG. 10. Only differences from the fifth embodiment will be explained below.

In this embodiment, in step S1619 of FIGS. 12A and 12B, the Web browser 440 sets the URL of the maintenance window in FIG. 10, and sends an HTTP request to the internal server 495. This allows to display the maintenance window in FIG. 10 without inquiring of a Web server 103.

According to this embodiment, the number of window requests to the Web server 103 can further be decreased, in addition to the fifth embodiment. This allows to further reduce process load of the Web server 103 and prevent an increase in network traffic.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-218004, filed Sep. 18, 2009, which is hereby incorporated by reference herein in its entirety.

What is claimed is:

1. An information processing apparatus which is connected to a server for providing a file to display a user interface, and displays the user interface based on the file, comprising:
an acquisition unit configured to acquire device information of the information processing apparatus;
a determination unit configured to determine, based on the device information acquired by said acquisition unit, whether a function of the information processing apparatus is usable;
a first request unit configured to, upon determining that the function of the information processing apparatus is usable, request, of the server, a file to display an execution instruction window of processing using the function of the information processing apparatus; and
a second request unit configured to, upon determining that the function of the information processing apparatus is not usable, request a file to display a warning window of the server.

2. The apparatus according to claim 1, further comprising a reception unit configured to receive, via the displayed user interface, a designation of the processing using the function of the information processing apparatus,
wherein when said reception unit receives the designation, said acquisition unit acquires the device information of the information processing apparatus.

3. The apparatus according to claim 1, further comprising:
a reception unit configured to receive, via the displayed user interface, a designation of the processing using the function of the information processing apparatus;
an authentication determination unit configured to determine, when said reception unit receives the designation, whether the information processing apparatus is in a login state or a logout state; and
a third request unit configured to, upon determining that the information processing apparatus is in the logout state, request a file to display an authentication window of the server.

4. A user interface display control method executed in an information processing apparatus which is connected to a server for providing a file to display a user interface, and displays the user interface based on the file, comprising the steps of:
acquiring device information of the information processing apparatus;
determining, based on the device information acquired in the step of acquiring the device information, whether a function of the information processing apparatus is usable; upon determining that the function of the information processing apparatus is usable, requesting, of the server, a file to display an execution instruction window of processing using the function of the information processing apparatus; and
upon determining that the function of the information processing apparatus is not usable, requesting a file to display a warning window of the server.

5. A computer-readable storage medium storing a program which is executed in an information processing apparatus which is connected to a server for providing a file to display a user interface, and displays the user interface based on the file, the program causing a computer to function to:
acquire device information of the information processing apparatus;
determine, based on the acquired device information, whether a function of the information processing apparatus is usable;
upon determining that the function of the information processing apparatus is usable, request, of the server, a file to display an execution instruction window of processing using the function of the information processing apparatus; and
upon determining that the function of the information processing apparatus is not usable, request a file to display a warning window of the server.
